(19) United States
(12) Patent Application Publication
(10) Pub. No.: US 2026/0285040 A1
(43) Pub. Date: Sep. 24, 2026

(54) LIQUID EJECTION HEAD

(71) Applicant: RISO Technologies Corporation, Tokyo (JP)

(72) Inventor: Ryutaro KUSUNOKI, Mishima Shizuoka (JP)

(21) Appl. No.: 19/396,320

(22) Filed: Nov. 20, 2025

(30) Foreign Application Priority Data
Jan. 29, 2025 (JP) 2025-013229

(51) Int. Cl. B41J 2/14; B41J 2/055

(52) U.S. Cl. CPC B41J 2/14274; B41J 2/055; B41J 2002/14475; B41J 2202/11; B41J 2202/12

(57) ABSTRACT

A liquid ejection head includes nozzles for ejecting a liquid, pressure chambers communicating with the nozzles, a supply-side flow path, an ejection-side flow path, and piezoelectric elements. When a viscous resistance of each nozzle is Rn, an inertial resistance of each nozzle is Mn, a meniscus compliance of each nozzle is Cn, viscous and inertial resistances of the supply-side flow path are Rm1 and Mm1, viscous and inertial resistances from the supply-side flow path to each nozzle are Rc1 and Mc1, viscous and inertial resistances from each nozzle to the ejection-side flow path are Rc2 and Mc2, and resistance and inertial resistances of the ejection-side flow path are Rm2 and Mm2, and M=Mn+1/(1/Mc1+1/Mc2)+1/(1/Mm1+1/Mm2), R=Rn+1/(1/Rc1+1/Rc2)+1/(1/Rm1+1/Rm2), ω=(M×Cn)^{-1/2}, and γ=R/2/M, 0.2≤γ²/ω²≤1.0 is satisfied.

### CROSS-REFERENCE TO RELATED APPLICATION

This application is based upon and claims the benefit of priority from Japanese Patent Application No. 2025-013229, filed on Jan. 29, 2025, the entire contents of which are incorporated herein by reference.

### FIELD

Embodiments described herein relate generally to a liquid ejection head.

### BACKGROUND

In a liquid ejection head such as an inkjet head, a push mode type liquid ejection head is known in which a pressure chamber facing a vibration plate is deformed by deforming the vibration plate using an actuator formed of a piezoelectric body such as lead zirconate titanate (PZT) such that ink is ejected from a nozzle that communicates with the pressure chamber.

In such a liquid ejection head, a method is used in which a nozzle is disposed at the center of the pressure chamber, a supply-side flow path is disposed on one side of the pressure chamber, an ejection-side flow path is disposed on the other side, and viscous resistances of the supply-side flow path and the ejection-side flow path are made equal to each other to circulate ink. Printing speed can be increased by optimizing the viscous resistance from the flow path to the nozzle and stabilizing the meniscus behavior when the ink is refilled in the nozzle after the ink ejection, but in the circulation type inkjet head, the viscous resistance increases, and ink circulation can become difficult.

### BRIEF DESCRIPTION OF THE DRAWINGS

FIG. 1 is a cross-sectional view illustrating an inkjet head according to a first embodiment.

FIG. 2 is a cross-sectional view illustrating the inkjet head.

FIG. 3 is a diagram illustrating the inkjet head.

FIG. 4 is a diagram illustrating an example of a drive signal.

FIG. 5 is a diagram of a flow path.

FIG. 6 is a diagram illustrating a shape of a nozzle.

FIG. 7 is a diagram illustrating the shape of the nozzle.

FIG. 8 is a diagram illustrating a relationship between a configuration of the nozzle and inertial resistance, viscous resistance, refill characteristics, and circulation characteristics.

FIG. 9 is a diagram illustrating an inkjet head according to another embodiment.

### DETAILED DESCRIPTION

Embodiments of this disclosure provide a liquid ejection head capable of stabilizing the meniscus behavior.

In general, according to one embodiment, a liquid ejection head comprises a nozzle plate having a plurality of nozzles for ejecting a liquid; a plurality of pressure chambers respectively communicating with the plurality of nozzles; a supply-side flow path on one side of the plurality of pressure chambers in one direction; an ejection-side flow path on the other side of the pressure chambers in the one direction; and a plurality of piezoelectric elements configured to deform when a voltage is applied to drive the pressure chambers. When a viscous resistance of each of the nozzles is defined as Rn, an inertial resistance of each of the nozzles is defined as Mn, a meniscus compliance of each of the nozzles is defined as Cn, viscous and inertial resistances of the supply-side flow path are defined as Rm1 and Mm1, viscous and inertial resistances from the supply-side flow path to each of the nozzles are defined as Rc1 and Mc1, viscous and inertial resistances from each of the nozzles to the ejection-side flow path are defined as Rc2 and Mc2, and resistance and inertial resistances of the ejection-side flow path are defined as Rm2 and Mm2, and
M=Mn+1/(1/Mc1+1/Mc2)+1/(1/Mm1+1/Mm2),
R=Rn+1/(1/Rc1+1/Rc2)+1/(1/Rm1+1/Rm2),
ω=(M×Cn)^{-1/2}, and
γ=R/2/M,
0.2≤γ²/ω²≤1.0 is satisfied.

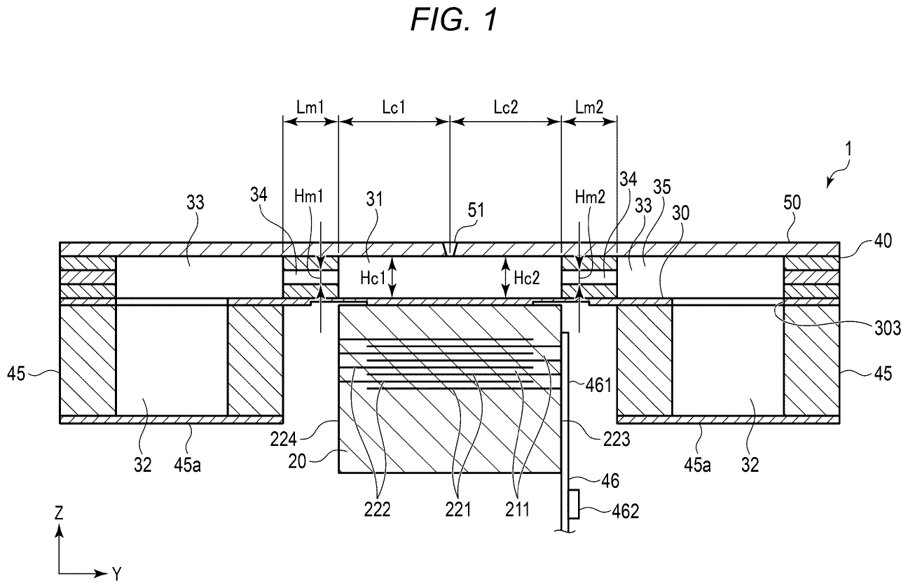

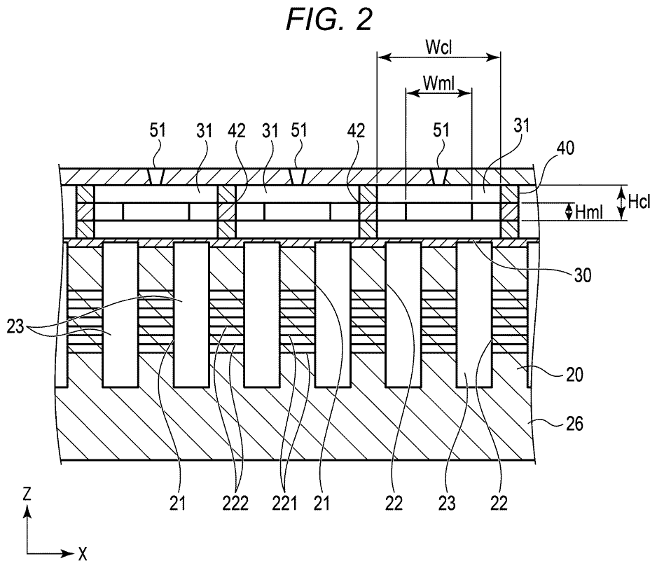

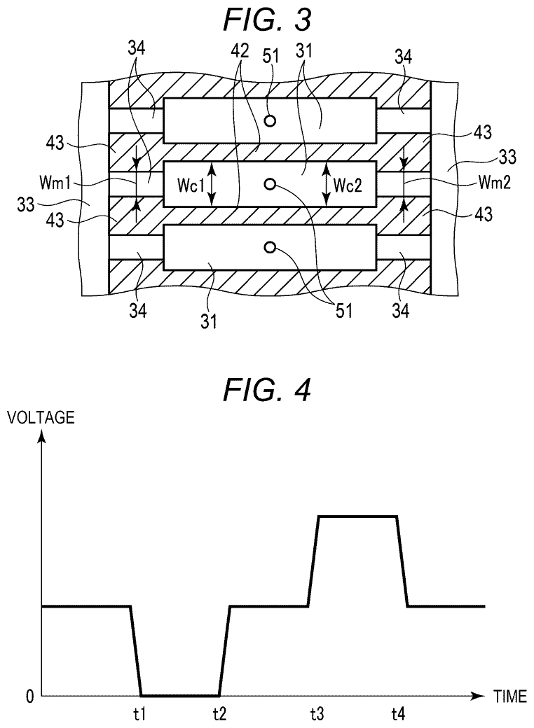

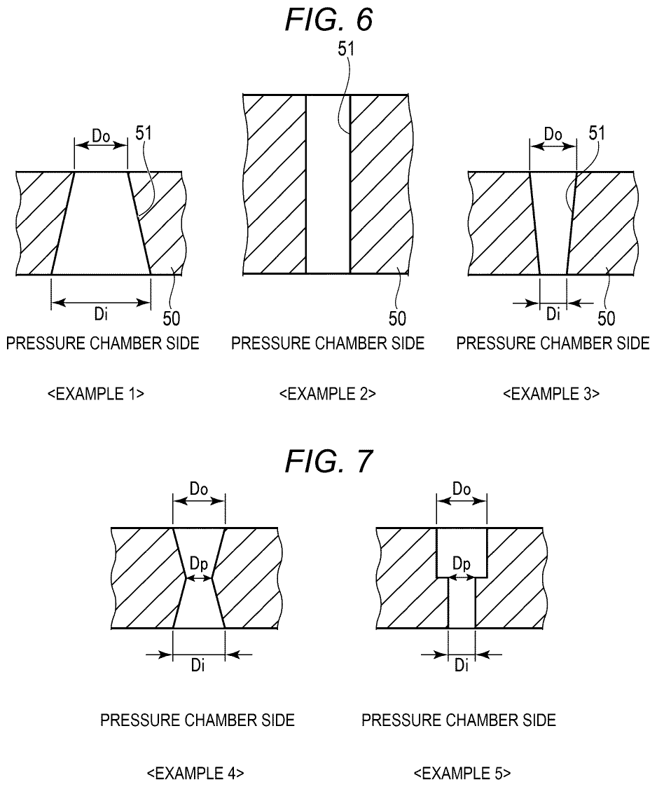

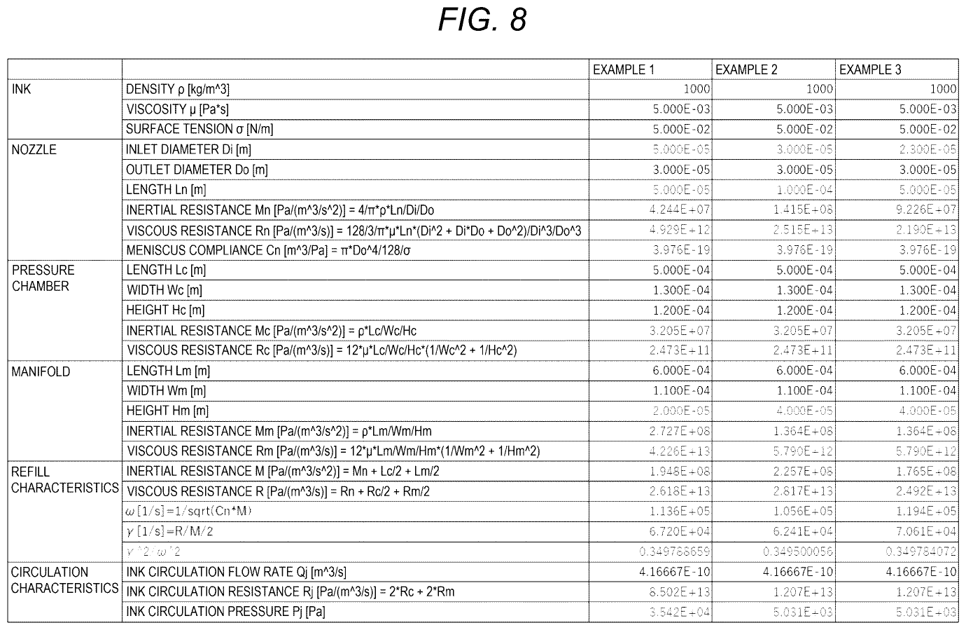

Hereinafter, an inkjet head 1 according to a first embodiment will be described with reference to FIGS. 1 to 6. FIGS. 1 and 2 are cross-sectional views illustrating the inkjet head 1 according to a first embodiment. FIG. 3 is a diagram illustrating the inkjet head 1 in the first embodiment. FIG. 4 is a diagram of a flow path in the inkjet head, and FIGS. 6 and 7 are diagrams illustrating examples of a shape of a nozzle. FIG. 8 is a diagram illustrating a relationship between a configuration of a nozzle and inertial resistance, viscous resistance, refill characteristics, and circulation characteristics. In the drawings, a configuration is illustrated enlarged, reduced, or omitted as appropriate for the purpose of description.

FIGS. 1 and 2 are a longitudinal cross-sectional view and a transverse cross-sectional view illustrating the inkjet head 1 according to the present embodiment. The inkjet head 1 includes an actuator portion 20, a vibration plate 30, a flow path portion 40 including a plurality of flow path plates, a nozzle plate 50 including a plurality of nozzles 51, a frame portion 45 serving as a structure portion, and a drive circuit 46 serving as a drive unit. The inkjet head 1 is a liquid ejection head provided in a liquid ejection apparatus such as an inkjet recording apparatus.

The actuator portion 20 includes, for example, piezoelectric members. In the present embodiment, the actuator portion 20 includes a plurality of drive piezoelectric elements 21 and a plurality of non-drive piezoelectric elements 22 serving as actuators alternately arranged along a row direction, and a piezoelectric structure portion 26 that integrally couples the plurality of piezoelectric elements 21 and 22.

The actuator portion 20 is divided into a plurality of portions by a plurality of grooves 23, and the plurality of drive piezoelectric elements 21 and the plurality of non-drive piezoelectric elements 22 are formed side by side in the row direction at the same pitch. Both the plurality of drive piezoelectric elements 21 and the plurality of non-drive piezoelectric elements 22 are formed in rectangular columnar shapes having the same outer shape.

Piezoelectric members constituting the drive piezoelectric elements 21 and the non-drive piezoelectric elements 22 are, for example, stacked piezoelectric bodies. Each of the drive piezoelectric element 21 and the non-drive piezoelectric element 22 includes a plurality of stacked piezoelectric layers 211 and internal electrodes 221 and 222 formed on a main surface of each of the piezoelectric layers 211. For example, the drive piezoelectric elements 21 and the non-drive piezoelectric elements 22 have the same stacked structure. The drive piezoelectric element 21 includes external electrodes 223 and 224 formed on a surface thereof. For example, one end of each of the drive piezoelectric element 21 and the non-drive piezoelectric element 22 is in contact with the vibration plate 30, and the other end is connected to the piezoelectric structure portion 26 serving as a support member. The drive piezoelectric element 21 is electrically connected to a driver IC 462 mounted on a wiring substrate 461 such as a flexible wiring board through an individual electrode and a common electrode. Meanwhile, an electrode of the non-drive piezoelectric element 22 (support column portion) is not electrically connected to the driver IC 462, and serves as a support column that supports the vibration plate 30 at a position corresponding to a partition wall portion 42.

The piezoelectric layer 211 is formed of a piezoelectric material such as a lead zirconate titanate (PZT) based material or a lead-free sodium potassium niobate (KNN) based material. The plurality of piezoelectric layers 211 are stacked in a thickness direction along the stacking direction. For example, in the present embodiment, the thickness direction and the stacking direction of the piezoelectric layers 211 are oriented along the vibration direction (Z direction).

The internal electrodes 221 and 222 are conductive films formed in a predetermined shape and formed of a sinterable conductive material such as silver palladium. The internal electrodes 221 and 222 have different poles. For example, the internal electrode 221 is formed in a region reaching one end portion of the piezoelectric layer 211 and not reaching the other end portion of the piezoelectric layer 211 in the extending direction (Y direction) orthogonal to both the vibration direction (Z direction) and the row direction (X direction) which is an arrangement direction of the plurality of drive piezoelectric elements 21 and the plurality of non-drive piezoelectric elements 22. The other internal electrode 222 is formed in a region not reaching one end portion of the piezoelectric layer 211 but reaching the other end portion of the piezoelectric layer 211 in the extending direction. The internal electrodes 221 and 222 are connected to the external electrodes 223 and 224 formed on the side surfaces of the piezoelectric elements 21 and 22, respectively.

The external electrodes 223 and 224 are formed on the surfaces of the plurality of drive piezoelectric elements 21, and are formed by collecting end portions of the internal electrodes 221 and 222. For example, the external electrode 223 and the external electrode 224 are respectively formed on one end surface and the other end surface in the extending direction of the piezoelectric layer 211, and respectively serve as a common electrode and an individual electrode.

The external electrodes 223 and 224 are connected to a drive circuit via, for example, a wiring substrate.

In the inkjet head 1, the drive piezoelectric element 21 vibrates when a voltage is applied to the internal electrodes 221 and 222 from the wiring substrate 461 via the external electrodes 223 and 224. In the present embodiment, the drive piezoelectric elements 21 perform longitudinal vibration along the stacking direction of the piezoelectric layers 211 to displace the vibration plate 30 and deform the pressure chamber 31.

The vibration plate 30 extends along a plane orthogonal to the Z direction which is a vibration direction, and is bonded to one side in the vibration direction of the piezoelectric layers 211 of the plurality of piezoelectric elements 21 and 22, that is, a surface on a side close to the nozzle plate 50. The vibration plate 30 faces the plurality of nozzles 51 via the pressure chambers 31 in the Z direction which is the vibration direction. The vibration plate 30 is deformable and bonded to the drive piezoelectric elements 21 and the non-drive piezoelectric elements 22 of the actuator portion 20 and the frame portion 45. The vibration plate 30 is provided between the flow path portion 40 and the actuator portion 20 in the vibration direction. The vibration plate 30 is disposed to overlap the plurality of flow path plates and constitutes a part of the ink flow path 35. The vibration plate 30 is bonded to an end surface of the actuator portion 20 by adhesion or the like.

The flow path portion 40 includes a plurality of flow path plates to be stacked. For example, a plurality of flow path plates having openings or grooves, the nozzle plate 50, and the vibration plate 30 are combined and bonded to form the desired ink flow path 35 according to ink viscosity, a volume of the ink to be ejected, and the like. The plurality of flow path plates are stacked in the stacking direction, and openings or grooves formed in the flow path plates form the predetermined ink flow path 35 including the pressure chambers 31 that communicate with the plurality of nozzles 51, common flow paths 33 that communicate with common chambers 32, and resistance flow paths 34.

For example, three flow path plates are stacked in order from a side close to the vibration plate 30, and one flow path plate is disposed to face the nozzle plate 50.

The flow path portion 40 is disposed between the nozzle plate 50 and the vibration plate 30. The flow path portion 40 is formed by stacking and bonding the plurality of flow path plates to form the predetermined ink flow path 35 (liquid chamber) including, therein, the plurality of pressure chambers 31, the common flow paths 33 that communicate with the common chambers 32, and the plurality of resistance flow paths 34 (throttle portion) extending from the common flow paths 33 to the pressure chambers 31. In other words, the flow path portion 40 is formed by the plurality of stacked flow path plates, and includes a peripheral wall portion that surrounds the ink flow path 35 (liquid chamber) including the plurality of pressure chambers 31, the plurality of resistance flow paths 34, and the common flow paths 33, and includes the plurality of the partition wall portions 42 that partition rows of the plurality of pressure chambers 31, and side wall portions 43 that partition the plurality of resistance flow paths 34. The common flow path 33 is a flow path connecting the resistance flow path 34 and the common chamber 32, and one common flow path 33 is connected to the plurality of resistance flow paths 34. For example, the resistance flow path 34 is a throttle flow path having a smaller flow path cross section than the pressure chamber 31. The resistance flow path 34 has a flow path cross section orthogonal to the Y direction which is the extending direction of the flow path smaller than that of the pressure chamber 31, and for example, in the present embodiment, a width and a height are set to be smaller than those of the pressure chamber 31. In the present embodiment, one side of the pressure chamber 31 in the extending direction is a supply-side flow path, and the other side is an ejection-side flow path. That is, the flow path portion 40 is implemented such that the supply-side flow path and the ejection-side flow path are formed to communicate respectively on one side and the other side in the extending direction with the pressure chamber 31 as the center, and the liquid flows from the supply-side flow path on one side into the pressure chamber 31, and flows from the pressure chamber 31 to the other side through the ejection-side flow path. The supply-side and the ejection-side flow paths may be formed symmetrically. The viscous and inertial resistances of the supply-side and ejection-side flow paths may be equal.

The nozzle plate 50 is formed of a resin material such as polyimide, and has a rectangular plate shape with a thickness of about 10 μm to 100 μm. The nozzle plate 50 is disposed on one side of the flow path portion 40 to cover an opening on one side of the pressure chamber 31. That is, the nozzle plate 50 is disposed on the side of the pressure chamber 31 opposite to the vibration plate 30. The nozzle plate 50 has a plurality of nozzles 51 that eject liquid droplets. The plurality of nozzles 51 are holes that pass through the nozzle plate 50 in the thickness direction. The plurality of nozzles 51 are arranged in the X direction, which is the same as the arrangement direction of the pressure chambers 31 to form a nozzle row. The nozzles 51 are provided corresponding to the plurality of pressure chambers 31, respectively.

The nozzles 51 are formed at the center of the nozzle plate 50 in the extending direction, and are fluidly connected to the respective pressure chambers 31. Here, the nozzle 51 is formed such that an inlet diameter Di or an inner diameter Dp is equal to or smaller than an outlet diameter Do. For example, the nozzle 51 has a truncated cone shape whose diameter increases from its inlet to the outlet on the pressure chamber 31 side. That is, the nozzle 51 is formed such that the outlet diameter Do on the ink ejection side is larger than the inlet diameter Di. For example, a viscous resistance Rn of the nozzle is greater than a viscous resistance Rm1 of the supply-side resistance flow path 34 or a viscous resistance Rm2 of the ejection-side resistance flow path 34.

The frame portion 45 is a structure bonded to the vibration plate 30 together with the piezoelectric elements 21 and 22. The frame portion 45 is provided on a side of the vibration plate 30 opposite to the flow path portion 40. For example, the frame portion 45 is adjacent to the actuator portion 20 in the present embodiment. The frame portion 45 is an outer shell of the inkjet head 1. The frame portion 45 is formed with a liquid flow path therein. In the present embodiment, the frame portion 45 is bonded to the other side of the vibration plate 30, and the common chamber 32 is formed between the frame portion 45 and the vibration plate 30. For example, some walls of the frame portion 45 may be implemented by deformable damper members 45a.

The common chamber 32 is formed inside the frame portion 45 and communicates with the pressure chamber 31 through an opening 303 provided in the vibration plate 30, the common flow path 33, and the resistance flow path 34.

The drive circuit 46 includes various wiring substrates 461 and the driver ICs 462. The drive circuit 46 is a drive waveform generation unit that generates and outputs a drive waveform according to a drive signal applied to a drive element. The driver IC 462 is electrically connected to electrodes of the actuator portion 20 via a wiring of the wiring substrate 461. The drive circuit 46 drives the actuator portion 20 by outputting a drive signal, increases or decreases a volume of the pressure chamber 31, and ejects a liquid droplet from the nozzle 51 disposed to face the pressure chamber 31.

In the inkjet head 1 implemented as described above, the nozzle plate 50, the frame portion 45, the flow path portion 40, and the vibration plate 30 form the ink flow path 35 including the plurality of pressure chambers 31 communicating with the nozzles 51, the individual flow path including the resistance flow path 34 communicating with the plurality of pressure chambers 31, and the common flow path 33 and the common chamber 32 connected to the plurality of individual flow paths to supply or eject the ink. For example, the common chamber 32 communicates with an ink supply tube or a cartridge, and the ink is supplied to each of the pressure chambers 31 through the common chamber 32. That is, in the inkjet head 1, the plurality of nozzles 51 for ejecting the liquid are arranged, and the plurality of pressure chambers 31 communicating with each of the nozzles 51 and the partition wall portions 42 partitioning the adjacent pressure chambers 31 are alternately arranged. In addition, a plurality of piezoelectric elements for driving and piezoelectric elements serving as the support columns are alternately formed. The piezoelectric element is connected so that a voltage can be applied to wiring.

In the inkjet head 1, the partition wall portion 42 has a condition that the ejection speed or the ejection volume when a single nozzle is driven is equivalent to the ejection speed or the ejection volume when a plurality of adjacent nozzles are simultaneously driven. In the present embodiment, the compliance of the partition wall portion 42 is set such that the ejection speed or the ejection volume when the single nozzle is driven is equivalent to the ejection speed or the ejection volume when a plurality of adjacent nozzles are simultaneously driven.

In the inkjet head 1, when a drive voltage is applied to the electrodes 221 and 222 by the drive circuit 46 in a state of being filled with ink, the piezoelectric element 21 to be driven vibrates in the stacking direction, that is, in the thickness direction of each of the piezoelectric layers 211. That is, the piezoelectric element 21 vibrates longitudinally. Specifically, the drive circuit 46 selectively drives the piezoelectric element 21 to be driven by applying a drive voltage to the internal electrodes 221 and 222 of the piezoelectric element 21 to be driven. Then, the vibration plate 30 is deformed by expanding and contracting the piezoelectric element 21 by combining deformation in a tensile direction and deformation in a compression direction, and the liquid is guided from the common chamber 32 and ejected from the nozzle 51 by changing the volume of the pressure chamber 31.

FIG. 4 is a diagram illustrating an example of the drive signal according to the first embodiment. In FIG. 4, a vertical axis represents a voltage [V], and a horizontal axis represents a time [μs]. For example, as illustrated in FIG. 4, the inkjet head 1 stands by in a state in which a voltage is applied to the drive piezoelectric element 21 before an ink ejection operation, and the drive piezoelectric element 21 is extended. When the voltage of the drive signal decreases at t1, the extended drive piezoelectric element 21 contracts, the volume of the pressure chamber 31 increases, and an ink pressure in the pressure chamber 31 decreases. When the pressure decreases, the ink flows in from the nozzle 51 and the resistance flow path 34, and the ink pressure increases. At t2, when the ink pressure increases most and the voltage of the drive signal increases at the same time, the volume of the pressure chamber 31 contracts, the ink pressure in the pressure chamber 31 further increases, and the ink is ejected from the nozzle 51. Thereafter, a generated pressure vibration is canceled by a voltage change between t3 and t4, and the inkjet head 1 returns to the standby state.

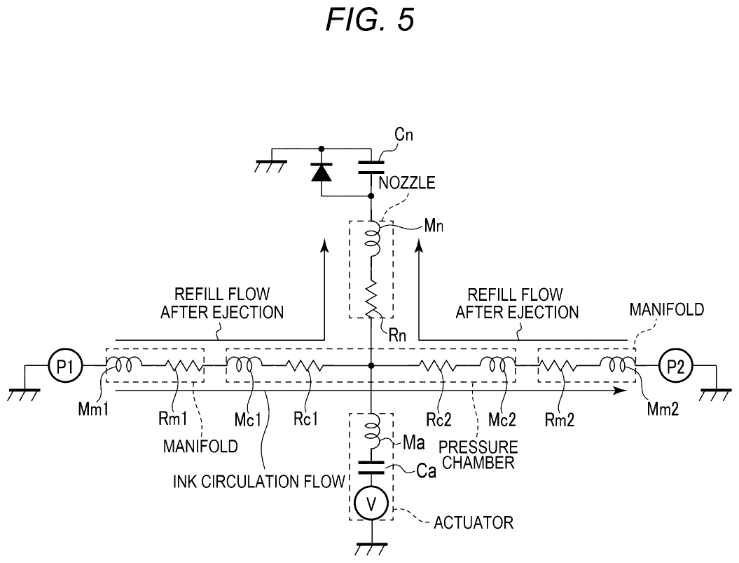

FIG. 5 is a diagram illustrating an equivalent circuit of the inkjet head according to the present example. A voltage corresponds to an ink pressure P, and a current corresponds to an ink flow rate. The inertial and viscous resistances with respect to the nozzle 51, the pressure chamber 31, and the resistance flow path 34 communicating with the pressure chamber 31 are represented by Mn, Rn, Mc, Rc, Mm, and Rm, respectively. A volume displacement with respect to the pressure of a meniscus of the nozzle 51, that is, a meniscus compliance is denoted by Cn.

Assuming that an ink density is ρ, a viscosity is μ, a surface tension is σ, an inlet diameter of the nozzle is Di, an outlet diameter is Do, a length of the nozzle is Ln, a length from the resistance flow path of the pressure chamber on the ink supply side to the nozzle is Lc1, a width is Wc1, a height is Hc1, a length of the resistance flow path is Lm1, a width is Wm1, and a height is Hm1, a length from the resistance flow path of the pressure chamber on the ink ejection side to the nozzle is Lc2, a width is Wc2, a height is Hc2, a length of a resistance flow path is Lm2, a width is Wm2, and a height is Hm2, each circuit constant of the equivalent circuit in FIG. 5 can be calculated by the following equation. The width Wm1 is a dimension in a direction orthogonal to the length Lm1. The height Hm1 is a dimension in a direction orthogonal to both the length Lm1 and the width Wm1.

Nozzle inertial resistance Mn=4/π×ρ×Ln/Di/Do

Nozzle viscous resistance Rn=128/3/π×μ×Ln×(Di²+Di×Do+Do²)/Di³/Do³

Pressure chamber inertial resistance Mc1=ρ×Lc1/Wc1/Hc1

Pressure chamber inertial resistance Mc2=ρ×Lc2/Wc2/Hc2

Pressure chamber viscous resistance Rc1=12×μ×Lc1/Wc1/Hc1*(1/Wc1²+1/Hc1²)

Pressure chamber viscous resistance Rc2=12×μ×Lc2/Wc2/Hc2*(1/Wc2²+1/Hc2²)

Supply-side resistance flow path inertial resistance Mm1=ρ×Lm1/Wm1/Hm1

Ejection-side resistance flow path inertial resistance Mm2=ρ×Lm2/Wm2/Hm2

Supply-side resistance flow path viscous resistance Rm1=12×μ×Lm1/Wm1/Hm1*(1/Wm1²+1/Hm1²)

Ejection-side resistance flow path viscous resistance Rm2=12×μ×Lm2/Wm2/Hm2*(1/Wm2²+1/Hm2²)

Meniscus compliance Cn=π/128/σ×Do⁴

A meniscus behavior in the equivalent circuit model will be described. The ink is ejected from the nozzle 51, and then the ink in the nozzle 51 decreases by an amount of the ejected ink, and returns by a surface tension of the meniscus in the nozzle 51. When a meniscus volume displacement at this time (time t) is v(t),
v(t)/Cn=−(Mn+1/(1/Mc1+1/Mc2)+1/(1/Mm1+1/Mm2))d²v(t)/dt²−(Rn+1/(1/Rc1+1/Rc2)+1/(1/Rm1+1/Rm2))v(t)/dt. Here, assuming that
M=Mn+1/(1/Mc1+1/Mc2)+1/(1/Mm1+1/Mm2),
R=Rn+1/(1/Rc1+1/Rc2)+1/(1/Rm1+1/Rm2),
ω32 (M×Cn)^{-1/2},
γ=R/2/M,
when 0.2≤γ²/ω²≤1.0, a meniscus recovery time can be shortened.

That is, when γ2/ω2>1, a meniscus volume position v(t) is in an overdamped state, and although there is no overshoot of the meniscus, a meniscus recovery speed is slow. When γ2/ω2<1, the meniscus volume position v(t) is in a damped vibration state, and the meniscus recovers at a high speed but overshoots. On the other hand, when γ2=ω2, that is, γ2/ω2=1, the meniscus volume position v(t) is in a critical damping state, and the meniscus recovery speed is the fastest under the condition that the meniscus does not overshoot. However, in practice, when the overshoot is small as in the case of γ2/ω2=0.5, the overshoot can be allowed, and the time until a meniscus variation falls within an allowable value, that is, the meniscus recovery time can be further shortened.

Therefore, by determining the dimensions of each part to satisfy the equation, the meniscus recovery time can be shortened. In the equivalent circuit model, in the ink circulation, an ink circulation resistance Rj is
Rj=Rm1+Rc1+Rc2+Rm2, and
an ink circulation pressure Pj for obtaining an ink circulation flow rate Qj is Pj=P1−P2=Rj×Qj.

FIG. 8 illustrates comparison results of the inkjet head having a nozzle shape illustrated in FIG. 6 based on the above equivalent circuit. FIG. 8 illustrates a correspondence between dimensional conditions of each part, the viscous and inertial resistances, γ2/ω2, which is a factor of the meniscus behavior as a refill characteristic, and an ink circulation pressure as a circulation characteristic, for a plurality of Examples 1, 2, and 3, which have different nozzle shapes and dimensional relationships.

In Example 1, the nozzle inlet diameter Di is 50 μm, the nozzle outlet diameter Do is larger than 30 μm, a nozzle length Ln is 50 μm, and the nozzle viscous resistance Rn is 4.93e12 Pa/(m\hat{ }3/s). The height of the resistance flow path is 20 μm, and the viscous resistances Rm1 and Rm2 of the resistance flow path are 4.23e13 Pa/(m\hat{ }3/s).

In Example 2, the inlet diameter Di of the nozzle and the outlet diameter Do are both 30 μm, and the nozzle length Ln is 100 μm, which is long. The nozzle viscous resistance Rn is 2.51e13 Pa/(m\hat{ }3/s). The height of the resistance flow path is 40 μm, and the viscous resistances Rm1 and Rm2 of the resistance flow path are 5.79e12 Pa/(m\hat{ }3/s). The nozzle viscous resistance Rn is greater than the viscous resistances Rm1 and Rm2 of the resistance flow path.

In Example 3, the inlet diameter Di of the nozzle is 23 μm, the nozzle outlet diameter Do is 30 μm, and the nozzle length Ln is 50 μm. The nozzle viscous resistance Rn is 2.19e13 Pa/(m\hat{ }3/s). The height of the resistance flow path is 40 μm, and the viscous resistances Rm1 and Rm2 of the resistance flow path are 5.79e12 Pa/(m\hat{ }3/s). The nozzle viscous resistance Rn is greater than the viscous resistances Rm1 and Rm2 of the resistance flow path.

It can be seen from FIG. 8 that the nozzle viscous resistance Rn is much greater in Examples 2 and 3 than in Example 1. Meanwhile, the resistance flow path viscous resistance Rm is much less in Examples 2 and 3 than in Example 1. In addition, γ2/ω2 which is the factor of the meniscus behavior is about 0.35, and Example 1, Example 2, and Example 3 are substantially the same.

Meanwhile, the ink circulation pressure Pj for the ink circulation flow rate Qj=4.16e−10 m\hat{ }3/s (=30 ml/min/1200 ch) is 35.42 kPa in Example 1, but decreases to 5.03 kPa in Examples 2 and 3. Therefore, by making the diameter of the nozzle in a longitudinal direction as small as possible, preferably equal to or smaller than the outlet diameter, the ink is more easily circulated.

In comparison between Example 2 and Example 3, Example 3 is less than Example 2 in the inertial resistance Mn and the viscous resistance Rn of the nozzle, and has higher driving efficiency in the ink ejection operation. As described above, when the nozzle viscous resistance Rn is increased, it is desirable to reduce the diameter of the nozzle rather than increasing the length Ln of the nozzle. However, when the nozzle outlet diameter Do is reduced, the meniscus compliance Cn is reduced, ω is increased, and γ²/ω² is likely to be reduced. Therefore, it is desirable to reduce the inner diameter Dp of the nozzle or the inlet diameter Di rather than reducing the nozzle outlet diameter Do. That is, it is desirable that a flow path cross-sectional area of the inside or inlet of the nozzle is smaller than a flow path cross-sectional area of the outlet of the nozzle.

According to the inkjet head 1 in the present embodiment, the meniscus behavior can be stabilized by determining the dimensions of each part to satisfy 0.2≤γ2/ω2≤1.0. Further, in the embodiment described above, by reducing the inner diameter Dp of the nozzle or the inlet diameter Di instead of reducing the nozzle outlet diameter Do, it is possible to provide a configuration in which the ink is more easily circulated.

Although one embodiment according to the present disclosure has been described in detail above, the present disclosure is not limited to the above-described embodiment, and modifications, improvements, and the like can be made as appropriate.

For example, in Example 1, the nozzle 51 has a truncated cone shape that is reduced toward an ejection side, and in Example 3, the nozzle 51 has a truncated cone shape that is reduced toward an inlet side, but embodiments of this disclosure are not limited thereto. For example, as illustrated in Example 4, the nozzle 51 may have a shape in which the diameter is reduced at a predetermined position inside the nozzle 51 between the inlet and the outlet and is enlarged toward the inlet and the outlet. For example, in the configuration illustrated in Example 4, the inlet diameter Di and the outlet diameter Do of the nozzle 51 are equal, and the inner diameter Dp is the smallest. Even in the configuration in which the inner diameter Dp is smaller than the outlet diameter Do, the ink is easily circulated. As illustrated in Example 5, a step may be provided instead of the conical shape. For example, the nozzle 51 in Example 5 is formed to have a step with a small diameter in a middle portion thereof. Even in such a shape, the ink is easily circulated by setting the inner diameter Dp to be smaller than the outlet diameter Do.

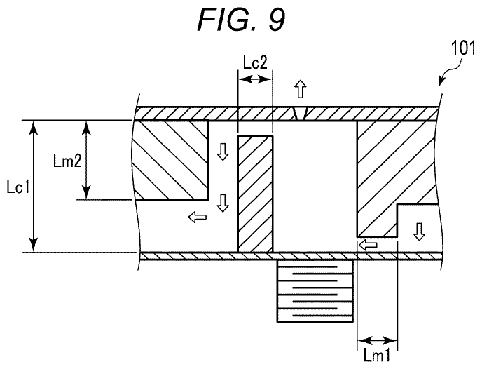

In addition, the present disclosure is not limited to the circulation type in which the supply-side flow path and the ejection-side flow path are symmetrical as illustrated in the above embodiment, and can be applied to an asymmetric configuration. For example, as in the inkjet head 101 illustrated in FIG. 9 as another embodiment, even in the case of an asymmetric configuration, the meniscus behavior can be stabilized by determining the dimensions of each part to satisfy the Equation of 0.2≤γ2/ω2≤1.0.

In addition, in the above-described embodiment, the resistance flow path 34 is a throttle flow path in which the dimensions in the width direction and the height direction are smaller than those of the pressure chamber 31, but embodiments of this disclosure are not limited thereto. For example, the width may be the same as that of the pressure chamber 31, or the height may be the same as that of the pressure chamber 31.

The actuator element is not limited to a stacked piezoelectric body, and may be a single layer.

According to at least one embodiment described above, it is possible to easily circulate the ink while stabilizing the meniscus behavior.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head comprising:
a nozzle plate having a plurality of nozzles for ejecting a liquid;
a plurality of pressure chambers respectively communicating with the plurality of nozzles;
a supply-side flow path on one side of the plurality of pressure chambers in one direction;
an ejection-side flow path on the other side of the pressure chambers in the one direction; and
a plurality of piezoelectric elements configured to deform when a voltage is applied to drive the pressure chambers, wherein
when a viscous resistance of each of the nozzles is defined as Rn, an inertial resistance of each of the nozzles is defined as Mn, a meniscus compliance of each of the nozzles is defined as Cn, viscous and inertial resistances of the supply-side flow path are defined as Rm1 and Mm1, viscous and inertial resistances from the supply-side flow path to each of the nozzles are defined as Rc1 and Mc1, viscous and inertial resistances from each of the nozzles to the ejection-side flow path are defined as Rc2 and Mc2, and resistance and inertial resistances of the ejection-side flow path are defined as Rm2 and Mm2, and
M=Mn+1/(1/Mc1+1/Mc2)+1/(1/Mm1+1/Mm2),
R=Rn+1/(1/Rc1+1/Rc2)+1/(1/Rm1+1/Rm2),
ω=(M×Cn)−½, and
γ=R/2/M,
0.2≤γ2/ω2≤1.0 is satisfied.

2. The liquid ejection head according to claim 1, wherein
Rn is greater than Rm1 or Rm2.

3. The liquid ejection head according to claim 2, wherein
a diameter of an inlet of each of the nozzles is equal to or smaller than a diameter of an outlet of each of the nozzles.

4. The liquid ejection head according to claim 3, further comprising:
a vibration plate disposed to face each of the nozzles, wherein
Rm1 and Mm1 are viscous and inertial resistances in a resistance flow path having a smaller flow path cross-sectional area than each of the pressure chambers, and
the resistance and inertial resistances of the supply-side flow path are equal to the viscous and inertial resistances of the ejection-side flow path.

5. The liquid ejection head according to claim 2, wherein
an inner diameter of each of the nozzles is equal to or smaller than a diameter of an outlet of each of the nozzles.

6. The liquid ejection head according to claim 1, wherein
each of the nozzles has a cylindrical nozzle shape.

7. The liquid ejection head according to claim 1, wherein
each of the nozzles has a truncated cone shape in which a diameter increases from an inlet to an outlet of the nozzle.

8. The liquid ejection head according to claim 1, wherein
a diameter of each of the nozzles at a position between an inlet and an outlet of said each of the nozzles is smaller than diameters of the inlet and the outlet.

9. The liquid ejection head according to claim 1, wherein
each of the nozzles includes a step in which an inner diameter is reduced at a middle portion of the nozzle.

10. The liquid ejection head according to claim 1, wherein
the plurality of piezoelectric elements includes a plurality of drive piezoelectric elements and a plurality of non-drive piezoelectric elements alternately arranged.

11. The liquid ejection head according to claim 10, further comprising:
a vibration plate disposed to face each of the nozzles; and
a plurality of partition wall portions each partitioning adjacent pressure chambers, wherein
each of the non-drive piezoelectric elements supports the vibration plate at a position corresponding to one of the partition wall portions.

12. The liquid ejection head according to claim 10, wherein
each of the drive and non-drive piezoelectric elements includes a plurality of stacked piezoelectric layers.

13. The liquid ejection head according to claim 1, further comprising:
a vibration plate disposed to face each of the nozzles; and
a common chamber that communicates with each of the pressure chambers through an opening in the vibration plate and a common flow path.

14. The liquid ejection head according to claim 13, further comprising:
a frame bonded to the vibration plate and the piezoelectric elements.

15. The liquid ejection head according to claim 1, wherein
each of the nozzles is disposed at a center of a corresponding one of the plurality of pressure chambers.
